(19) United States
(12) Patent Application Publication
(10) Pub. No.: US 2024/0168987 A1
(43) Pub. Date: May 23, 2024

(54) DOCUMENT RETRIEVING APPARATUS AND DOCUMENT RETRIEVING METHOD

(71) Applicant: KABUSHIKI KAISHA TOSHIBA, Tokyo (JP)

(72) Inventors: Takami YOSHIDA, Kamakura Kanagawa (JP); Hisayoshi NAGAE, Yokohama Kanagawa (JP); Kenji IWATA, Machida Tokyo (JP)

(73) Assignee: KABUSHIKI KAISHA TOSHIBA, Tokyo (JP)

(21) Appl. No.: 18/454,806

(22) Filed: Aug. 24, 2023

(30) Foreign Application Priority Data
Nov. 18, 2022 (JP) 2022-185041

(51) Int. Cl. G06F 16/35; G06F 16/33

(52) U.S. Cl. CPC G06F 16/353; G06F 16/3344

(57) ABSTRACT

According to one embodiment, a document retrieving apparatus includes a memory and processing circuitry. The memory stores block information indicating a plurality of blocks and a plurality of reference features that is associated with the blocks, the blocks each being a group of semantically relevant sentences included in a document. The processing circuitry extracts a retrieval feature to be used in retrieval from a query that is input, retrieves a first block that is relevant to the query from the blocks based on matching of the retrieval feature with the reference features, and generates display information for conducting an emphasis display of the first block.

### CROSS-REFERENCE TO RELATED APPLICATION

This application is based upon and claims the benefit of priority from Japanese Patent Application No. 2022-185041, filed Nov. 18, 2022, the entire contents of which are incorporated herein by reference.

### FIELD

Embodiments described herein relate generally to a document retrieving apparatus and a document retrieving method.

### BACKGROUND

A document retrieving apparatus that retrieves, from a document, a sentence or a paragraph that is relevant to a query input by a user is known. In some general documents, semantically relevant information is distributed to a plurality of sentences or paragraphs, or plural pieces of information that are semantically different from each other are included in a single paragraph. Therefore, in some cases, a user needs to check not only a sentence indicated by the document retrieving apparatus but also sentences before and after the sentence, or not only information desired by a user but also information having low relevance to the information is included in a paragraph indicated by the document retrieving apparatus.

It is important that the document retrieving apparatus can easily retrieve desired information.

### BRIEF DESCRIPTION OF DRAWINGS

FIG. 1 is a block diagram illustrating a document retrieving system according to a first embodiment.

FIG. 2 is a block diagram illustrating a document retrieving apparatus according to the first embodiment.

FIG. 3 is a flowchart illustrating document analyzing processing according to the first embodiment.

FIG. 4 is a diagram for explaining block division according to the first embodiment.

FIG. 5 is a flowchart illustrating document retrieving processing according to the first embodiment.

FIG. 6 is a diagram illustrating an emphasis display according to the first embodiment.

FIG. 7 is a block diagram illustrating a document retrieving apparatus according to a variation of the first embodiment.

FIG. 8 is a flowchart illustrating document analyzing processing according to the variation of the first embodiment.

FIG. 9 is a diagram for explaining block integration according to the variation of the first embodiment. FIG. 10 is a flowchart illustrating document retrieving processing according to the variation of the first embodiment.

FIG. 11 is a diagram illustrating an emphasis display according to the variation of the first embodiment.

FIG. 12 is a block diagram illustrating a document retrieving apparatus according to a second embodiment.

FIG. 13 is a flowchart illustrating document retrieving processing according to the second embodiment.

FIG. 14 is a diagram illustrating block division and feature extraction according to the second embodiment.

FIG. 15 is a diagram illustrating a retrieval screen according to the second embodiment.

FIG. 16A is a diagram illustrating a retrieval screen according to the second embodiment.

FIG. 16B is a diagram illustrating a retrieval screen according to the second embodiment.

FIG. 17 is a diagram illustrating a retrieval screen according to the second embodiment.

FIG. 18 is a diagram illustrating a retrieval screen according to the second embodiment.

FIG. 19 is a block diagram illustrating a hardware configuration of a computer according to an embodiment.

### DETAILED DESCRIPTION

According to one embodiment, a document retrieving apparatus includes a memory and processing circuitry. The memory is configured to store block information indicating a plurality of blocks and a plurality of reference features that is associated with the blocks, the blocks each being a group of semantically relevant sentences included in a document. The processing circuitry is configured to extract a retrieval feature to be used in retrieval from a query that is input, retrieve a first block that is relevant to the query from the blocks based on matching of the retrieval feature with the reference features, and generate display information for conducting an emphasis display of the first block.

Hereinafter, embodiments will be described with reference to the accompanying drawings.

### First Embodiment

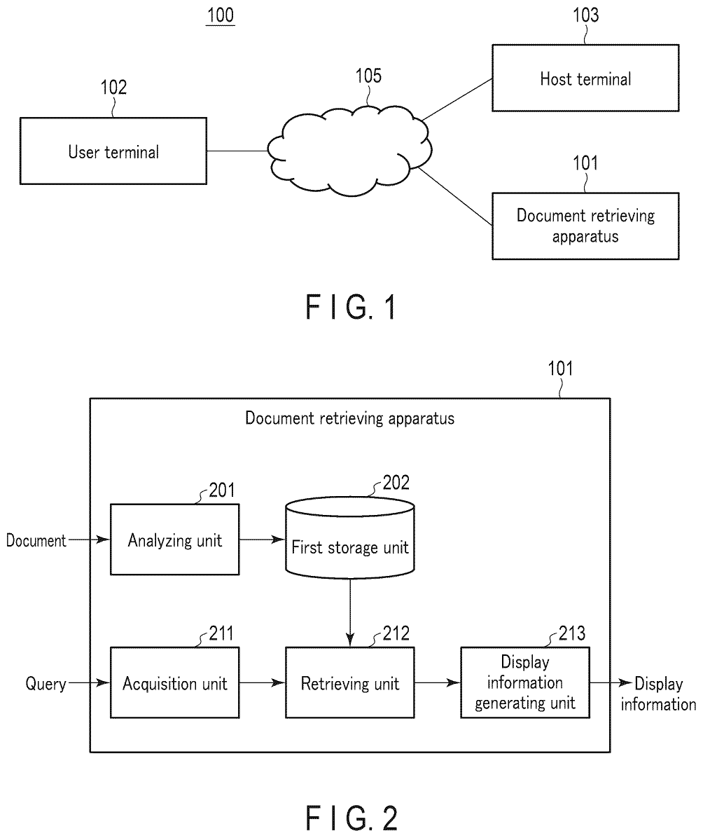

FIG. 1 schematically illustrates a document retrieving system 100 according to a first embodiment. As illustrated in FIG. 1, the document retrieving system 100 includes a document retrieving apparatus 101, a user terminal 102, and a host device 103. The document retrieving apparatus 101, the user terminal 102, and the host device 103 are connected to a communication network 105 that may include the Internet, and the document retrieving apparatus 101 performs communication with the user terminal 102 and the host device 103 via the communication network 105.

The document retrieving apparatus 101 may be implemented in a computer such as a server. The document retrieving apparatus 101 holds one or more documents to be published to users. The document retrieving apparatus 101 retrieves a document that is relevant to a query input by a user, and outputs its retrieval result to the user. An output of the retrieval result includes an emphasis display of a portion that is relevant to the query in a document that is hit in the retrieval.

The user terminal 102 may be a computer that is associated with a user, such as a personal computer or a smartphone. The user terminal 102 includes an input device such as a keyboard, and an output device including a display device. The input device is used to input information such as a query. The display device is used to display information, such as a retrieval result that is acquired by the document retrieving apparatus 101.

As an example, the document retrieving apparatus 101 is implemented as a Web application in a server, and the user terminal 102 accesses the document retrieving apparatus 101 by using a Web browser. If the user terminal 102 accesses the document retrieving apparatus 101, a retrieval screen including an input form for inputting a query is displayed on the Web browser. When a user inputs the query to the input form, the document retrieving apparatus 101 receives, from the user terminal 102, the query input by the user, performs document retrieval by using the received query, and acquires a retrieval result. The document retrieving apparatus 101 adds the retrieval result to the retrieval screen in order to present the retrieval result to the user by using the user terminal 102.

The host device 103 can be a computer, such as a personal computer, that is used by an administrator that administrates the document retrieving apparatus 101. For example, the host device 103 transmits, to the document retrieving apparatus 101, a document to be published to the user.

A system configuration illustrated in FIG. 1 is illustrative. The document retrieving apparatus 101 may be implemented in a local computer such as the user terminal 102. In a case where the document retrieving apparatus 101 is implemented in the local computer, the document retrieving apparatus 101 may be actualized as an application executed on the local computer.

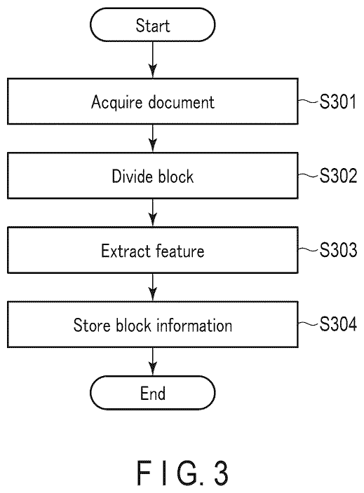

FIG. 2 schematically illustrates the document retrieving apparatus 101 according to the first embodiment. As illustrated in FIG. 2, the document retrieving apparatus 101 includes an analyzing unit 201, a first storage unit 202, an acquisition unit 211, a retrieving unit 212, and a display information generating unit 213.

The analyzing unit 201 acquires one or more documents, analyzes the documents, and stores the documents in the first storage unit 202 in association with an analysis result. For example, the analyzing unit 201 receives a document from the host device 103 illustrated in FIG. 1. The analyzing unit 201 divides the document into a plurality of blocks, which is each a group of sentences that are semantically relevant to each other in the document, and extracts, for each of the blocks, a feature to be used in retrieval from the block. Each of the blocks includes one or more sentences. One or more features may be extracted from one block. The feature extracted from the block is referred to at the time of retrieval, and is also referred to as a reference feature hereinafter. The analyzing unit 201 generates, as an analysis result, block information that includes division information indicating the blocks obtained by dividing the document, and reference feature information indicating reference features extracted from the respective blocks. The division information includes, for example, information indicating a division position of the block in the document.

The first storage unit 202 stores one or more documents and the block information for each of the documents. The block information for each of the documents indicates a plurality of blocks included in this document and reference features that is associated with the respective blocks.

The acquisition unit 211 acquires a query that is input by a user, and transmits the query to the retrieving unit 212. For example, the acquisition unit 211 receives the query from the user terminal 102. The query may be a sentence, or may be a keyword.

The retrieving unit 212 receives the query from the acquisition unit 211, and extracts, from the query, a feature to be used in retrieval. The feature extracted from the query is also referred to as a retrieval feature. Moreover, the retrieving unit 212 retrieves a block that is relevant to the query from the first storage unit 202, by using the retrieval feature. Specifically, the retrieving unit 212 retrieves a block that is relevant to the query from the blocks included in the block information based on matching of the retrieval feature with the reference features stored in the first storage unit 202. The retrieving unit 212 determines a block that is associated with the reference feature that matches the retrieval feature as a block that is relevant to the query. The retrieving unit 212 generates a retrieval result indicating a block that is hit in retrieval (the block that is relevant to the query), and transmits the retrieval result to the display information generating unit 213.

The display information generating unit 213 generates display information for conducting an emphasis display of the block that is hit in retrieval, and outputs the display information. The display information generating unit 213 transmits the display information to the user terminal 102. The user terminal 102 receives the display information from the document retrieving apparatus 101, and displays the display information in a display device. In the display device, the document is displayed in a state where the block that is relevant to the query that is input by the user is emphasized.

Next, an operation of the document retrieving apparatus 101 is described.

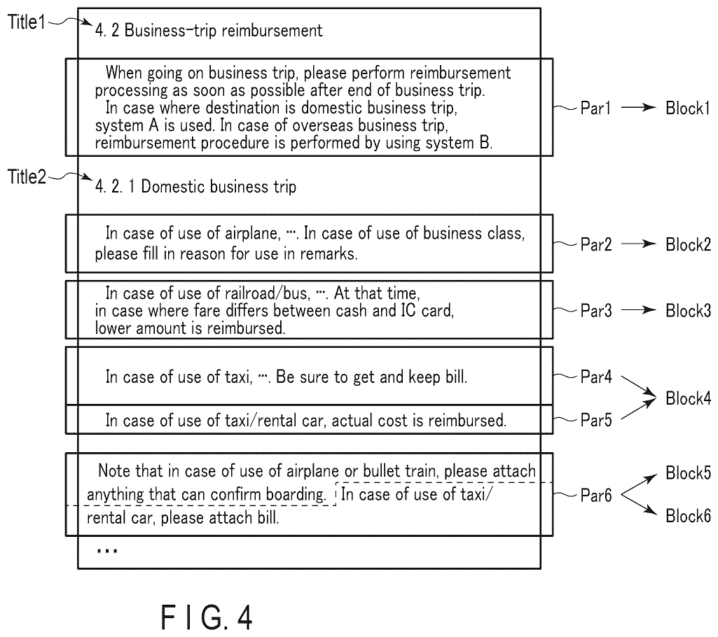

FIG. 3 schematically illustrates an example of a procedure of document analyzing processing according to the first embodiment. The document analyzing processing illustrated in FIG. 3 is advance preparation for enabling document retrieval.

In step S301, the analyzing unit 201 receives one or more documents that are input by an administrator. For example, the administrator specifies a document to be published to a user in the host device 103, and the host device 103 transmits the document specified by the administrator to the document retrieving apparatus 101. The analyzing unit 201 receives the document from the host device 103. The document may be a document that has a hierarchical structure, such as a chapter or a paragraph, or may be a document that does not have the hierarchical structure, such as text generated by performing speech recognition. The document may be a document file of any format such as HTML format, PDF format, or Word format. The analyzing unit 201 performs a series of processes illustrated in steps S302 to S304 on each of the documents.

In step S302, the analyzing unit 201 divides the received document into block units, and generates a plurality of blocks. In division into block units (block division), a deep learning model may be used. The analyzing unit 201 uses a deep learning model that has been learned in supervised learning in advance to estimate whether a block boundary is present between two sentences that are continuous in the document.

For example, the deep learning model is configured to receive two sentences as an input, and output a score indicating relevance between two sentences. The analyzing unit 201 inputs the two sentences that are continuous in the document to the deep learning model, and obtains a score that is output from the deep learning model. In the present embodiment, the score is defined to have a greater value as the two sentences have higher relevance. In a case where the score exceeds a predetermined threshold, the analyzing unit 201 determines that the block boundary is not present between the two sentences, and stated another way, the analyzing unit 201 determines that the two sentences will be caused to belong to the same block. In a case where the score is less than or equal to the predetermined threshold, the analyzing unit 201 determines that the block boundary is present between the two sentences, and stated another way, the analyzing unit 201 determines that the two sentences will be caused to belong to blocks different from each other. In another embodiment, the score may be defined to have a smaller value as the two sentences have higher relevance.

Alternatively, the deep learning model may be configured to convert a sentence into a vector. For example, the deep learning model is configured to receive one sentence as an input, and output a vector that expresses this sentence. The analyzing unit 201 inputs the sentences included in the document to the deep learning model one by one to acquire vectors that correspond to individual sentences. The analyzing unit 201 performs agglomerative clustering on these vectors to put together sentences having high relevance into a block.

A division result obtained by using any of the methods described above may be corrected according to a predetermined rule using structure information of the document. This correction processing can prevent occurrence of a situation where a large number of small blocks are generated or a small number of large blocks are generated. For example, it is assumed that an itemized form or a table included in a document includes N items or rows. In a case where N/2 or more pieces of blocks are generated as a result of performing block division on the itemized form or the table, the analyzing unit 201 determines one item or row as one block. In contrast, in a case where less than N/2 pieces of blocks are generated, the analyzing unit 201 the entirety of the itemized form or table as one block. In a case where the itemized form includes one item or the table includes one row, the analyzing unit 201 may correct the division result in such a way that the entirety of one item or one row forms one block.

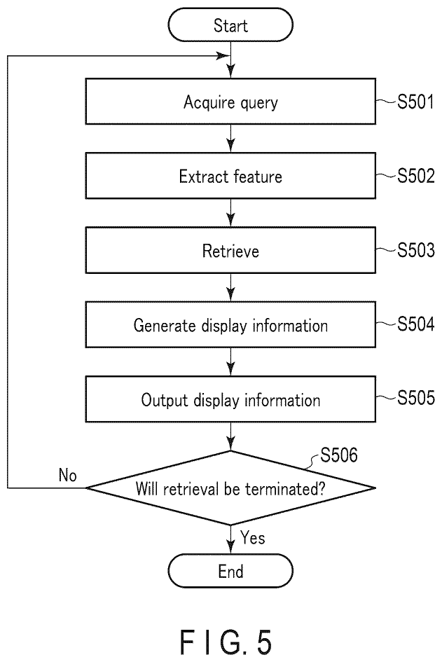

FIG. 4 illustrates an example of block division. In the example illustrated in FIG. 4, a document includes a section title Title1, a sub-section title Title2, and six paragraphs Par1 to Par6 each including one or more sentences. If the analyzing unit 201 performs block division, the paragraph Par1 is determined as a block Block1, the paragraph Par2 is determined as a block Block2, the paragraph Par3 is determined as a block Block3, the paragraphs Par4 and Par5 are determined as a block Block4, and the paragraph Par6 is divided into two blocks Block5 and Block6. In this manner, one paragraph is determined as one block in some cases, a plurality of paragraphs is determined as one block in some cases, and one paragraph is divided into a plurality of blocks in some cases.

Referring to FIG. 3 again, in step S303, the analyzing unit 201 extracts a feature to be used in retrieval as a reference feature from each of the blocks acquired in block division. As an example, the reference feature may be a list of keywords included in each of the blocks. In this case, the analyzing unit 201 may divide a sentence included in a block into words, may estimate a part of speech of each of the words, and may extract a noun or a verb as a keyword. The analyzing unit 201 may perform named entity extraction to extract named entity as the reference feature from the sentence included in the block.

In another example, the reference feature may be a vector that expresses a sentence included in each of the blocks. In this case, the analyzing unit 201 vectorizes a sentence by using a model that has been learned in advance. For example, the model is configured to use a sentence as an input, and output a vector that expresses this sentence. As the model, the recurrent neural network (RNN) or the bidirectional encoder representations from transformers (BERT) can be used. The analyzing unit 201 acquires a vector for each sentence included in one block.

Note that in a case where a document has a hierarchical structure, the analyzing unit 201 may extract the reference feature from not only the block but also a hierarchy that is higher than a hierarchy including the block. In this case, the analyzing unit 201 extracts the feature from titles of a chapter and a section to which a block of interest belongs in a method that is similar to a method for extracting the feature from a block. In the example illustrated in FIG. 4, the analyzing unit 201 extracts, as the reference feature, the keywords “airplane” and “business class” from sentences included in the block Block2. Moreover, the analyzing unit 201 extracts, as the reference feature, the keywords “business-trip reimbursement” and “domestic business trip” from titles Title1 and Title2 of higher-order hierarchies. These four keywords are associated as the reference features with the block Block2.

In step S304, the analyzing unit 201 stores, in the first storage unit 202, block information indicating a plurality of blocks acquired by dividing the document, and reference features that are associated with the blocks.

If the document analyzing processing illustrated in FIG. 3 is terminated, a user can retrieve the document by using the document retrieving apparatus 101.

Note that the document analyzing processing illustrated in FIG. 3 may be performed by an external apparatus that is different from the document retrieving apparatus 101, and the document retrieving apparatus 101 may receive block information from the external apparatus, and may store the block information in the first storage unit 202. Furthermore, the first storage unit 202 may be provided in the external apparatus.

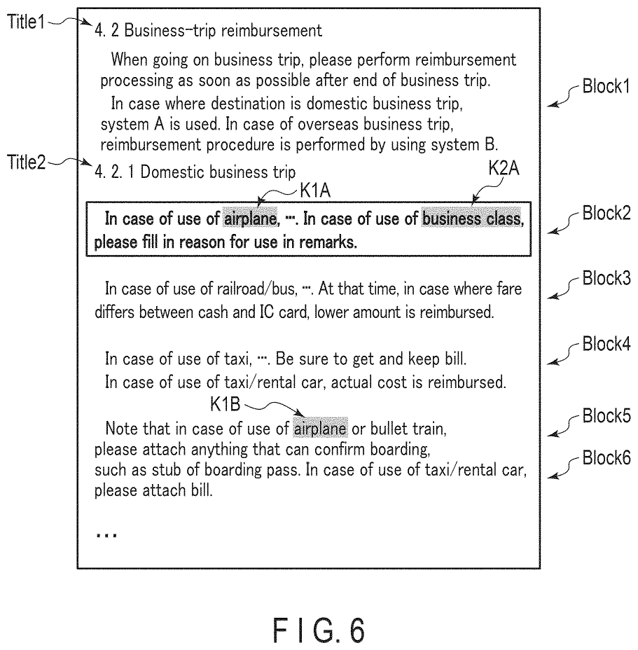

FIG. 5 schematically illustrates an example of a procedure of document retrieving processing according to the first embodiment.

In step S501 of FIG. 5, the acquisition unit 211 acquires a query that is input by a user. For example, the acquisition unit 211 receives the query from the user terminal 102. In an example where the document retrieving apparatus 101 is implemented in a local computer, the query may be input by using a keyboard or a touch panel that is included in the local computer, or may be obtained by performing speech recognition on an utterance sentence that is input as sound and converting the utterance sentence into text.

In step S502, the retrieving unit 212 extracts a feature to be used in retrieval as a retrieval feature from the query acquired in step S501. This feature extraction is performed according to a method that is similar to a method in which the analyzing unit 201 extracts a feature from each block included in a document.

In step S503, the retrieving unit 212 refers to the block information stored in the first storage unit 202 by using the retrieval feature, and retrieves a block that is relevant to the query. For example, the retrieving unit 212 determines the block that is relevant to the query by comparing the retrieval feature with the reference features included in the block information. In a case where a keyword is used as the feature, the retrieving unit 212 specifies a block that is associated with a reference feature (a reference keyword) that matches the retrieval feature (a retrieval keyword), as the block that is relevant to the query. A first feature matching a second feature includes that a first keyword serving as the first feature matches a second keyword serving as the second feature, and that the first keyword is a quasi-synonym, a synonym, or a homonym of the second keyword. In a case where a vector is used as the feature, a first feature matching a second feature includes, for example, that a degree of similarity (for example, cosine similarity) between a first vector serving as the first feature and a second vector serving as the second feature exceeds a predetermined threshold.

In a case where a keyword is used as the feature, the retrieving unit 212 may specify a block that includes all of the keywords that match a plurality of retrieval keywords, as the block that is relevant to the query. Alternatively, the retrieving unit 212 may specify a block that includes one or more keywords that match the retrieval keyword, as the block that is relevant to the query.

In a case where a plurality of blocks is extracted, these blocks may be ranked according to the order of appearance in the document. Alternatively, the blocks may be ranked according to the number or appearance frequency of keywords that match the retrieval keyword. In this case, the analyzing unit 201 counts the appearance frequency of each keyword in the block after extracting the keywords. The block information further includes the appearance frequency of each of the keywords.

In step S504, the display information generating unit 213 generates display information based on a retrieval result obtained in step S503. The display information generating unit 213 generates display information for conducting an emphasis display of a block that is relevant to a query from a user. Specifically, the display information generating unit 213 adds an instruction of emphasis display based on the retrieval result to the document in order to clearly indicate the block that is relevant to the query from the user. For example, in a case where the document is an HTML file, the display information generating unit 213 inserts an HTML tag into the block that is relevant to the query. As an example, the display information generating unit 213 indicates, in bold, the entirety of the block that is relevant to the query, and changes a font color and a background color of a keyword that matches a retrieval keyword extracted from the query. A method for emphasizing a block and a keyword may be a change in a font or a font size, or a character color or a background color, a change to a bold font, a change to italics, or a combination of two or more of them. Furthermore, instead of changing a font or a background color, the block may be emphasized using a format such as surrounding the entirety of the block with a rectangle. In a case where a plurality of blocks is hit in retrieval, the display information generating unit 213 emphasizes all of these blocks.

In step S505, the display information generating unit 213 outputs the generated display information. For example, the display information generating unit 213 transmits the display information to the user terminal 102. In an example where the document retrieving apparatus 101 is implemented in the local computer, the display information generating unit 213 displays the display information in a display device that is included in the computer or is connected to the computer.

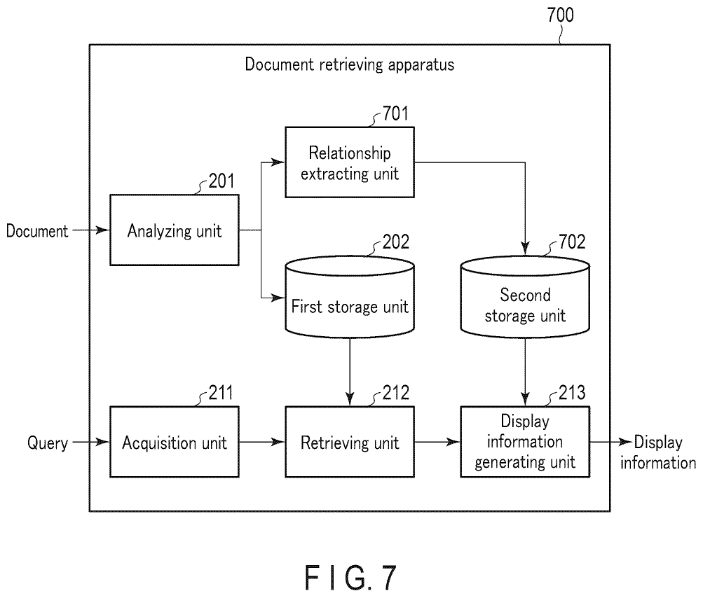

FIG. 6 illustrates an example of display information in a case where a user inputs the query “airplane, business class”. In the example illustrated in FIG. 6, the block Block2 includes both keywords “airplane” (K1A) and “business class” (K2A), and therefore the block Block2 is hit in retrieval. In the block Block2, the entirety is indicated in bold, and is surrounded with a rectangle, and moreover, the background colors of the keywords “airplane” (K1A) and “business class” (K2A) have been changed. In the block Block5, the background color of the keyword “airplane” (K1B) has been changed. The blocks Block1 and Block3 to Block6 that are not hit in retrieval are displayed using a normal format that does not emphasize the entirety.

By conducting such a display, a display is conducted in such a way that a portion that is hit in retrieval is easy to view, and blocks before and after the portion are easy to check.

Referring to FIG. 5 again, in step S506, whether retrieval performed by the user will be terminated is determined. In a case where retrieval will not be terminated (step S506; No), the flow returns to step S501, and the processes illustrated in steps S501 to S505 are performed on a new query input by the user. In a case where retrieval will be terminated (step S506; Yes), the flow is terminated.

As described above, in the first embodiment, the document retrieving apparatus 101 retrieves a block that is relevant to a query from a user in a document, and conducts an emphasis display of a block that is hit in retrieval. This enables a group of semantically relevant pieces of information to be displayed in a form that is easy for the user to view. For example, in a document in which one item (for example, a paragraph) includes two pieces of information that are semantically different from each other, or semantically relevant pieces of information are distributed in a plurality of items (for example, sentences or paragraphs), similarly, information can be displayed to be easily viewed. As a result, the user can efficiently discover desired information.

### Variation of First Embodiment

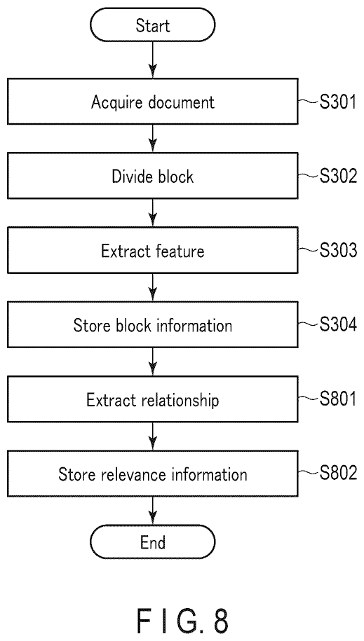

FIG. 7 schematically illustrates a document retrieving apparatus 700 according to a variation of the first embodiment. In FIG. 7, a portion that is similar to the portion illustrated in FIG. 2 is denoted by a similar reference sign, and a duplicate description is omitted. A system configuration according to the variation of the first embodiment is similar to the system configuration illustrated in FIG. 1.

As illustrated in FIG. 7, the document retrieving apparatus 700 includes an analyzing unit 201, a first storage unit 202, an acquisition unit 211, a retrieving unit 212, a display information generating unit 213, a relationship extracting unit 701, and a second storage unit 702. Stated another way, the document retrieving apparatus 700 corresponds to the document retrieving apparatus 101 illustrated in FIG. 2 with the relationship extracting unit 701 and the second storage unit 702 added. According to addition of the relationship extracting unit 701 and the second storage unit 702, an operation of the display information generating unit 213 is partially changed.

The relationship extracting unit 701 receives block information from the analyzing unit 201, estimates relevance between blocks, and stores, in the second storage unit 702, relevance information indicating semantic relevance between the blocks.

The display information generating unit 213 generates display information based on a retrieval result received from the retrieving unit 212 and the relevance information stored in the second storage unit 702.

Next, an operation of the document retrieving apparatus 700 is described.

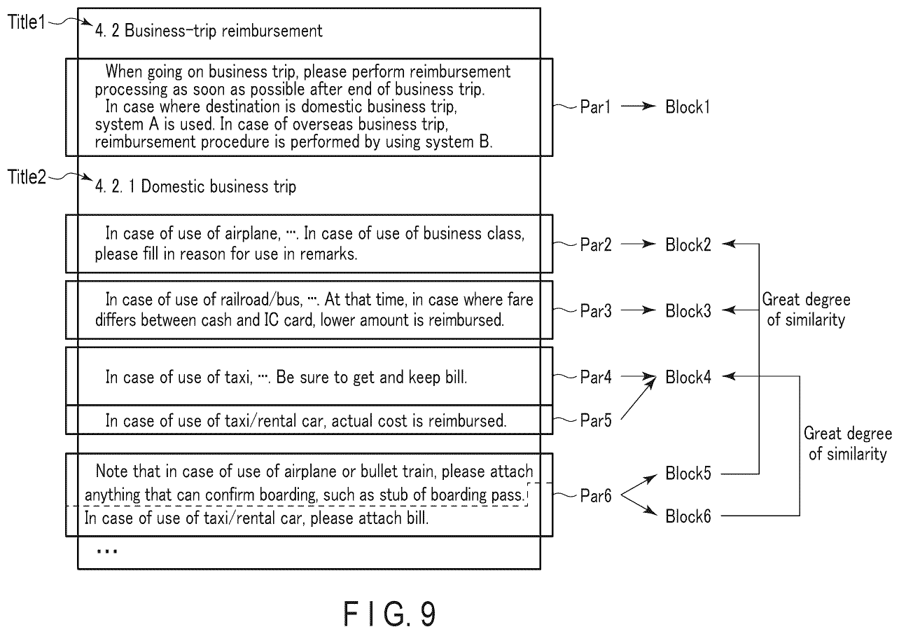

FIG. 8 schematically illustrates an example of a procedure of document analyzing processing according to the variation of the first embodiment. In FIG. 8, a process that is similar to the process illustrated in FIG. 3 is denoted by a similar reference sign, and a duplicate description is omitted. The document analyzing processing illustrated in FIG. 8 corresponds to the document analyzing processing illustrated in FIG. 3 with steps S801 and S802 added. In the example illustrated in FIG. 8, steps S801 and S802 are provided in a rear stage of step S304. Note that the processes illustrated as steps S801 and S802 may be performed prior to the process illustrated as step S303.

In step S801 of FIG. 8, the relationship extracting unit 701 receives block information acquired in step S302 from the analyzing unit 201, calculates a degree of similarity between blocks based on the block information, and generates relevance information indicating semantic relevance between the blocks based on the calculated degree of similarity. In an example where a document is divided into three blocks, a first block, a second block, and a third block, the degree of similarity between blocks includes a degree of similarity between the first block and the second block, a degree of similarity between the first block and the third block, and a degree of similarity between the second block and the third block.

The degree of similarity between blocks may be estimated by using a deep learning model that has been learned in advance. The relationship extracting unit 701 converts each of the blocks into one feature vector by using the model. The relationship extracting unit 701 calculates cosine similarity between two feature vectors that correspond to two blocks. The relationship extracting unit 701 determines that the two blocks are relevant to each other (the two blocks have high relevance) in a case where the calculated cosine similarity exceeds a predetermined threshold, and integrates these blocks. The relationship extracting unit 701 determines that the two blocks are not relevant to each other (the two blocks have low relevance) in a case where the calculated cosine similarity is equal to or less than the predetermined threshold, and does not integrate these blocks.

Alternatively, the relationship extracting unit 701 may obtain feature vectors from individual blocks and may perform clustering on the feature vectors to generate relevance information indicating semantic relevance between the blocks.

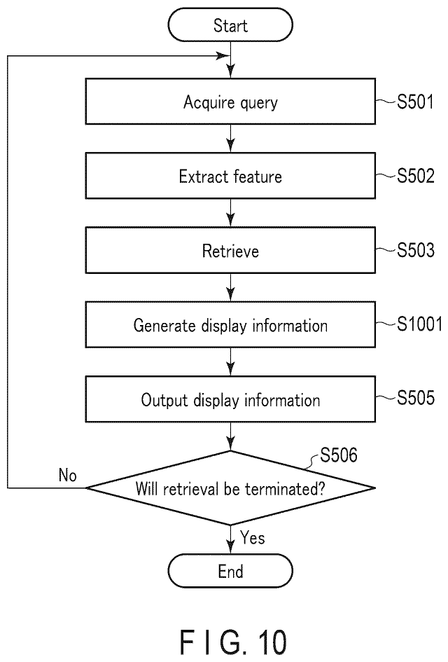

As illustrated in FIG. 9, in some cases, two blocks having high relevance in a sentence sandwich a block having low relevance to them. In this example, the blocks Block2 and Block5 include information relating to the use of an airplane, the blocks Block3 and Block5 include information relating to the use of a bullet train, and the blocks Block4 and Block6 include information relating to the use of a taxi and/or a rental car. For example, the blocks Block2 and Block5 include semantically relevant information, and therefore the blocks Block2 and Block5 have high relevance, and the blocks Block2 and Block5 are integrated. Furthermore, the block Block5 and the block Block2 have high relevance, the block Block5 and the block Block3 have high relevance, and the block Block5 is integrated with the blocks Block2 and Block3. As described above, one block may be integrated with a plurality of blocks. By integrating blocks having high relevance, semantically relevant information can be prevented from fragmenting.

Block integration may be performed in consideration of the number of characters included in a block. For example, blocks having a large number of characters are integrated with each other only in a case where a degree of similarity is sufficiently high, and blocks having a small number of characters are integrated with each other even in a case where a degree of similarity is not so high. By doing this, the number of characters included in a block is indirectly controlled, and generation of an excessively long block or generation of a large number of short blocks can be prevented.

In a case where there is a plurality of documents to be retrieved, targets to be integrated may be limited to targets in an identical document. In general, in many cases, different documents have different contents, and therefore there is a low probability that a block of a certain document and a block of another document have high relevance. By limiting targets to be integrated to targets in an identical document, calculation resources, such as the time spent for calculating a degree of similarity, can be reduced.

Referring to FIG. 8 again, in step S802, the relationship extracting unit 701 stores, in the second storage unit 702, relevance information indicating semantic relevance between blocks.

Note that the document analyzing processing illustrated in FIG. 8 may be performed by a computer that is different from the document retrieving apparatus 700, and the document retrieving apparatus 700 may receive block information and relevance information from the computer, may store the block information in the first storage unit 202, and may store the relevance information in the second storage unit 702. Furthermore, the first storage unit 202 and the second storage unit 702 may be provided in an external apparatus.

FIG. 10 schematically illustrates an example of a procedure of document retrieving processing according to the variation of the first embodiment. In FIG. 10, a process that is similar to the process illustrated in FIG. 5 is denoted by a similar reference sign, and a duplicate description is omitted. The document retrieving processing illustrated in FIG. 10 corresponds to the document retrieving processing illustrated in FIG. 5 in which the process illustrated as step S503 is changed to the process illustrated as step S1001.

In step S1001, the display information generating unit 213 generates display information based on a retrieval result received from the retrieving unit 212 and the relevance information stored in the second storage unit 702. The display information generating unit 213 refers to the relevance information, specifies a block having high relevance to a block indicated by the retrieval result (that is, a block that is relevant to a query that is input by a user), and generates display information for conducting an emphasis display of the block indicated by the retrieval result and the specified block.

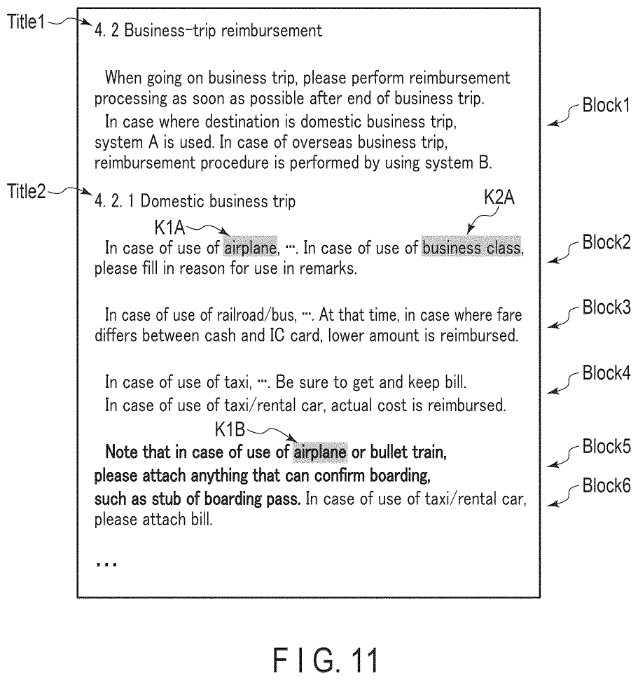

FIG. 11 illustrates an example of an emphasis display. In the example illustrated in FIG. 11, the block Block2 is determined as a block that is relevant to the query from the user, and the block Block2 is displayed in bold. As described above with reference to FIG. 9, the block Block2 is integrated with the block Block5. Therefore, Block5 is also displayed in bold. By conducting such a display, a user can easily grasp desired information.

In the example illustrated in FIG. 11, two blocks that are located relatively close to each other are integrated, and therefore the blocks Block3 and Block4 between them are displayed with no change. In a case where two blocks are apart from each other, blocks between them may be folded to be partially displayed. Folding enables the two blocks to be displayed in one screen, even in a case where the two blocks are not displayed in one screen if the blocks are displayed as they are, and a user can easily view them. In a case where a folded display is conducted, a button for releasing folding may be disposed nearby in order to display a folded portion.

Alternatively, a display may be conducted in the form of omitting interposed blocks. By doing this, a user can view collected pieces of information in a more concentrated manner. In the case of omission, a button for switching the display of the entire sentence and the display of only a corresponding block may be displayed in order to view relevant information.

### Second Embodiment

In the first embodiment, a plurality of blocks may be hit in retrieval. In a case where a plurality of blocks is hit in retrieval, it is effective to narrow a document retrieval result in order to acquire desired information. In a second embodiment, a user narrows a document retrieval result by using interaction with a chatbot.

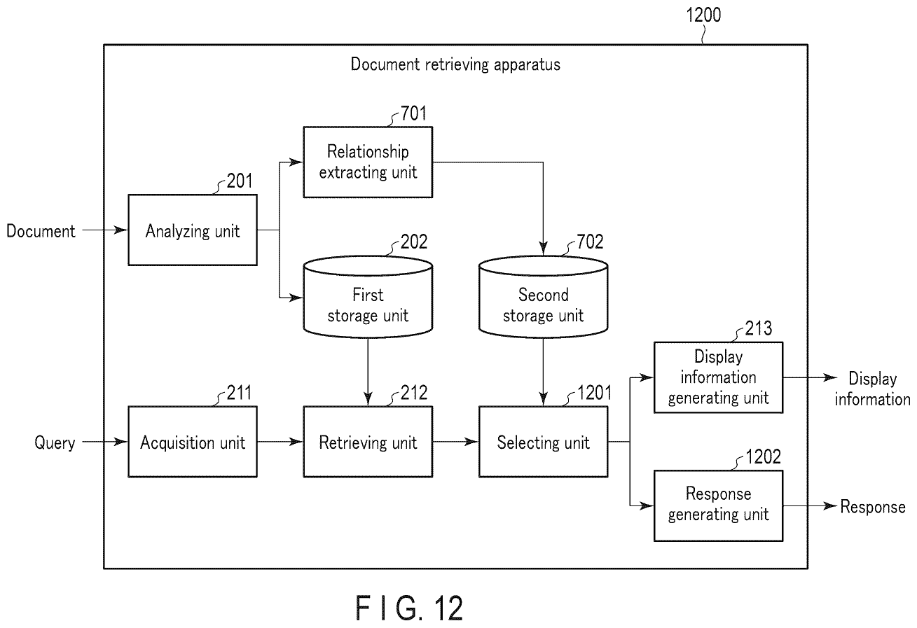

FIG. 12 schematically illustrates a document retrieving apparatus 1200 according to the second embodiment. In FIG. 12, a portion that is similar to the portion illustrated in FIG. 7 is denoted by a similar reference sign, and a duplicate description is omitted. A system configuration according to the second embodiment is similar to the system configuration illustrated in FIG. 1.

As illustrated in FIG. 12, the document retrieving apparatus 1200 includes an analyzing unit 201, a first storage unit 202, an acquisition unit 211, a retrieving unit 212, a display information generating unit 213, a selecting unit 1201, and a response generating unit 1202. Stated another way, the document retrieving apparatus 1200 corresponds to the document retrieving apparatus 700 illustrated in FIG. 7 with the selecting unit 1201 and the response generating unit 1202 added. According to addition of the selecting unit 1201, an operation of the display information generating unit 213 is partially changed.

The selecting unit 1201 selects a block to be used to generate display information and generate a response based on a retrieval result received from the retrieving unit 212 and relevance information stored in the second storage unit 702. In a case where a plurality of blocks is hit in retrieval, the selecting unit 1201 selects one block from these blocks, and transmits selection information indicating the selected block to the display information generating unit 213. For example, the retrieving unit 212 ranks the blocks that are hit in retrieval, and the selecting unit 1201 selects a block that ranks first. In a case where a plurality of blocks is hit in retrieval, the selecting unit 1201 determines a candidate for an additional query for narrowing a document retrieval result based on reference features associated with these blocks. For example, the selecting unit 1201 selects one or more reference features as an additional query candidate from the reference features associated with the blocks.

The display information generating unit 213 generates display information for displaying a list of the blocks that are hit in retrieval and displaying a document that includes the block selected by the selecting unit 1201.

The response generating unit 1202 generates and outputs a response that proposes the additional query candidate determined by the selecting unit 1201 and prompts a user to input an additional query.

Next, an operation of the document retrieving apparatus 1200 is described.

Document analyzing processing according to the second embodiment is the same as the document analyzing processing according to the variation of the first embodiment, and therefore the description of the document analyzing processing is omitted.

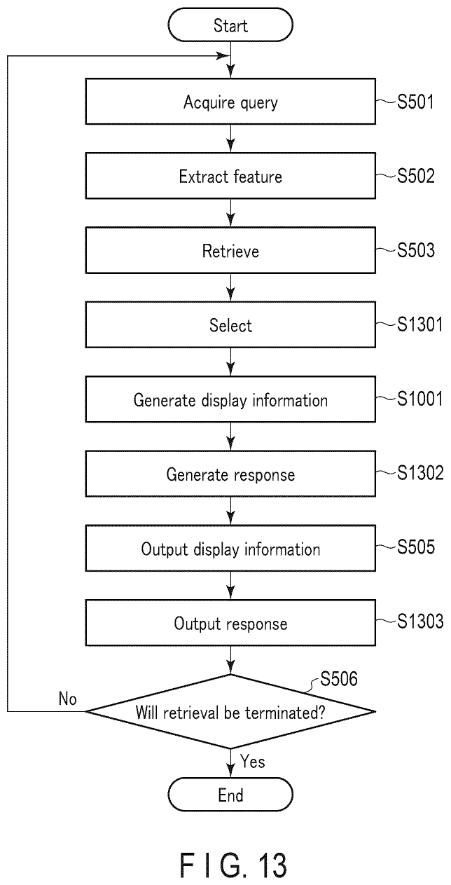

FIG. 13 schematically illustrates an example of a procedure of document retrieving processing according to the second embodiment. In FIG. 13, a portion that is similar to the portions illustrated in FIGS. 5 and 10 is denoted by a similar reference sign, and a duplicate description is omitted. The document retrieving processing illustrated in FIG. 13 corresponds to the document retrieving processing illustrated in FIG. 10 with steps S1301, S1302, and S1303 added.

As illustrated in FIG. 13, a flow moves on from step S503 in which the retrieving unit 212 performs retrieval to step S1301. In step S1301, the selecting unit 1201 selects a block to be used to generate display information and a response based on a retrieval result acquired by the retrieving unit 212 and relevance information stored in the second storage unit 702.

In step S1001, the display information generating unit 213 generates display information for displaying a list of a plurality of blocks that is hit in retrieval and displaying a document that includes the block selected by the selecting unit 1201.

In step S1302, the response generating unit 1202 generates a response based on the block selected by the selecting unit 1201 and the retrieval result acquired by the retrieving unit 212. For example, in a case where a plurality of blocks is hit in retrieval, the response generating unit 1202 generates a response based on the number of blocks that are hit in retrieval and a keyword that is different from a query that is input by a user. The keyword that is different from the query that is input by the user may be selected from reference features (keywords) that are associated with the blocks that are hit in retrieval.

In step S505, the display information generating unit 213 outputs display information, and in step S1303, the response generating unit 1202 outputs a response.

When the user inputs an additional query, the retrieving unit 212 performs retrieval by using the query that is input first and the additional query.

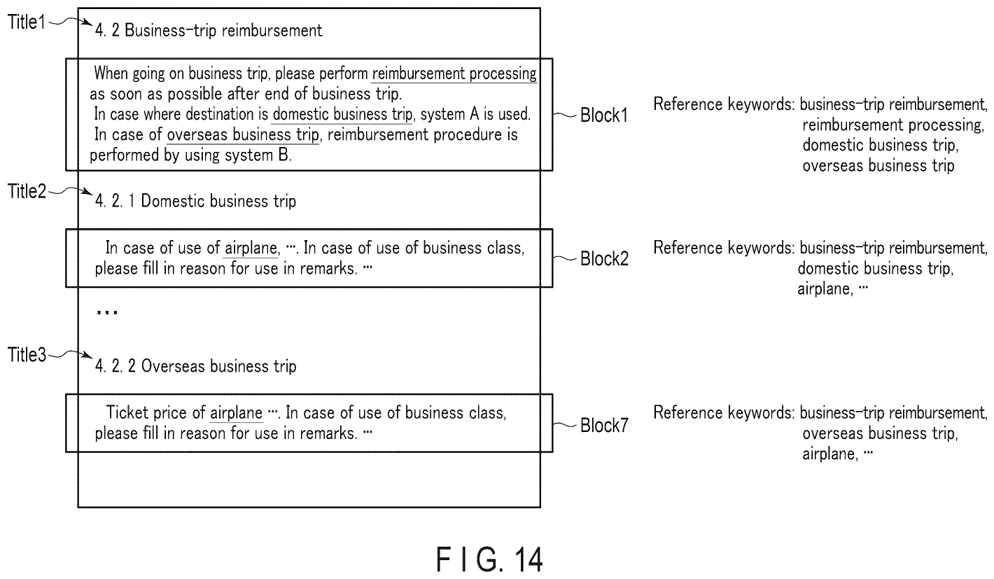

FIG. 14 illustrates an example of a keyword that is extracted as a reference feature. A reference feature serving as a keyword is also referred to as a reference keyword. In the example illustrated in FIG. 14, a block Block1 is associated with reference keywords including the keywords “reimbursement processing”, “domestic business trip”, and “overseas business trip” extracted from the block Block1, and the keyword “business-trip reimbursement” extracted from a section title Title1 serving as a hierarchy that is higher than a hierarchy including the block Block1. A block Block2 is associated with reference keywords including the keyword “airplane” extracted from the block Block2, and the keywords “business-trip reimbursement” and “domestic business trip” extracted from the section title Title1 and a sub-section title Title2 that serve as hierarchies that are higher than a hierarchy including the block Block2. A block Block7 is associated with reference keywords including the keyword “airplane” extracted from the block Block7, and the keywords “business-trip reimbursement” and “overseas business trip” extracted from the section title Title1 and a sub-section title Title3 that serve as hierarchies that are higher than a hierarchy including the block Block7.

In a case where a retrieval result indicates that a plurality of blocks is hit in retrieval, the response generating unit 1202 generates a response that includes a keyword that is included in any of the blocks that are hit in retrieval, and also includes a keyword that is not mentioned by the user.

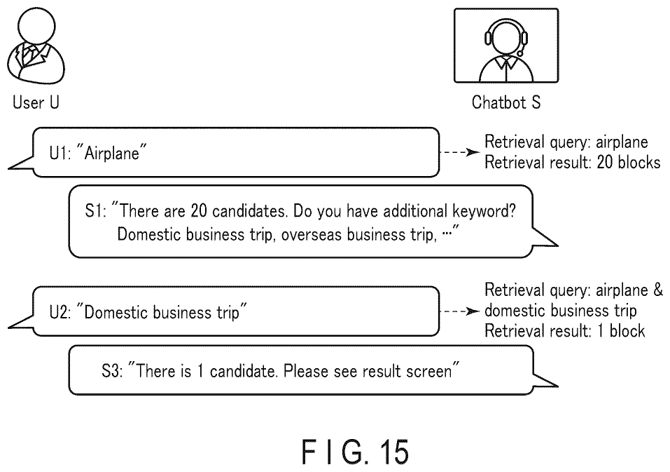

As illustrated in FIG. 15, if a user U input the keyword “airplane” as a retrieval query, 20 blocks including the blocks Block2 and Block7 are hit in retrieval. The response generating unit 1202 sets a reference keyword associated with these blocks as an additional keyword candidate. In this example, the additional keyword candidate includes the keywords “airplane”, “business-trip reimbursement”, “domestic business trip”, “overseas business trip”, and the like. The keyword “airplane” that the user U input as the retrieval query is excluded from the additional keyword candidate. Moreover, the reference keyword “business-trip reimbursement” that is common to the blocks Block2 and Block7 is excluded from the additional keyword candidate. This is because a retrieval result fails to be narrowed even if the keyword “business-trip reimbursement” is input as the additional query by the user. As a result of this, the keywords “domestic business trip”, “overseas business trip”, and the like remain as the additional keyword candidates. The response generating unit 1202 generates a response that suggests the user to input the keywords “domestic business trip”, “overseas business trip”, or the like. A chatbot S presents to the user the response “There are 20 candidates. Do you have an additional keyword? Domestic business trip, overseas business trip, . . . ”. In response to this, if the user U inputs the keyword “domestic business trip” as the additional query, the block Block2 is hit in retrieval.

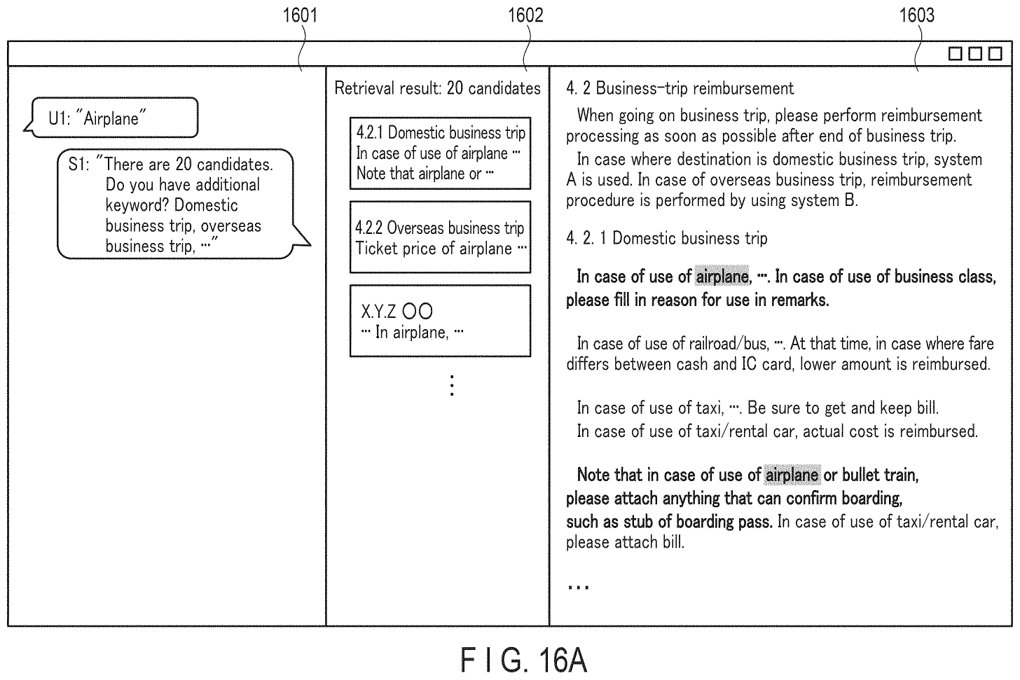

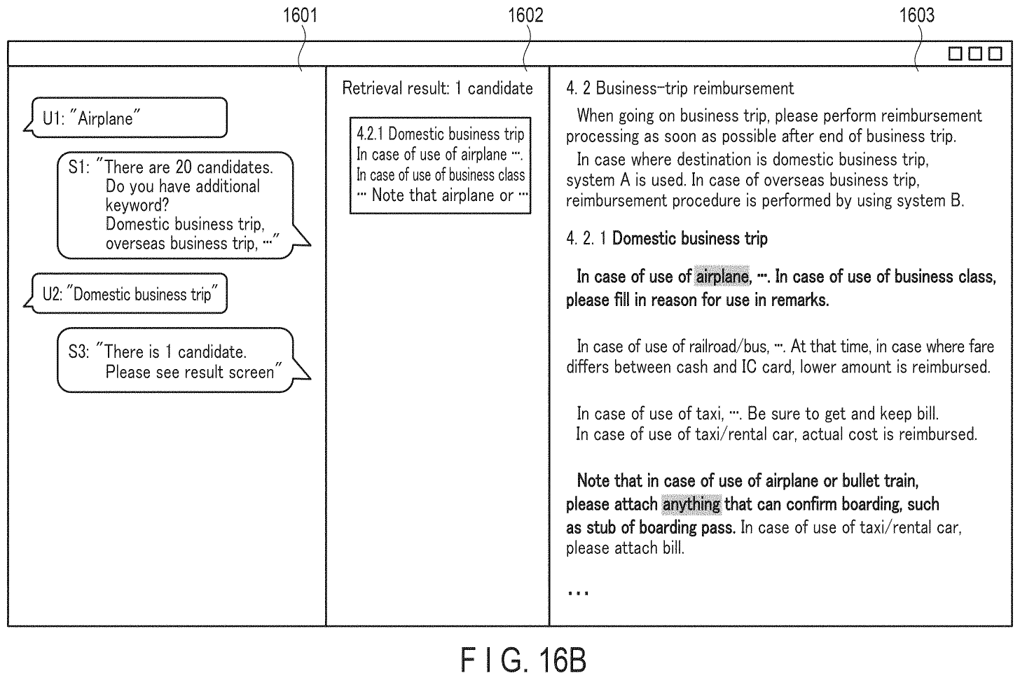

FIGS. 16A and 16B illustrate examples of a retrieval screen according to the second embodiment. Specifically, FIG. 16A illustrates a retrieval screen at a point in time when interaction of a first turn terminated, and FIG. 16B illustrates a retrieval screen at a point in time when interaction of a second turn terminated. As illustrated in FIG. 16A, the retrieval screen includes three regions 1601, 1602, and 1603, the history of interaction between a user and a chatbot is displayed in the region 1601, a list of blocks that are hit in retrieval is displayed in the region 1602, and a document around a block selected by the selecting unit 1201 is displayed in the region 1603.

At a point in time when the interaction of the first turn terminated, 20 blocks are hit in retrieval. A block that ranks first and relates to domestic business trip is selected, and a document including the selected block is displayed in the region 1603. As illustrated in FIG. 16B, at a point in time when the interaction of the second turn terminated, one block is hit in retrieval, and a document including this block is displayed in the region 1603. A retrieval feature (“domestic business trip”) that is extracted from an addition query input by the user matches a reference feature (“domestic business trip”) that is extracted from a title, and the title is emphasized in the document displayed in the region 1603. Specifically, the title is displayed in bold.

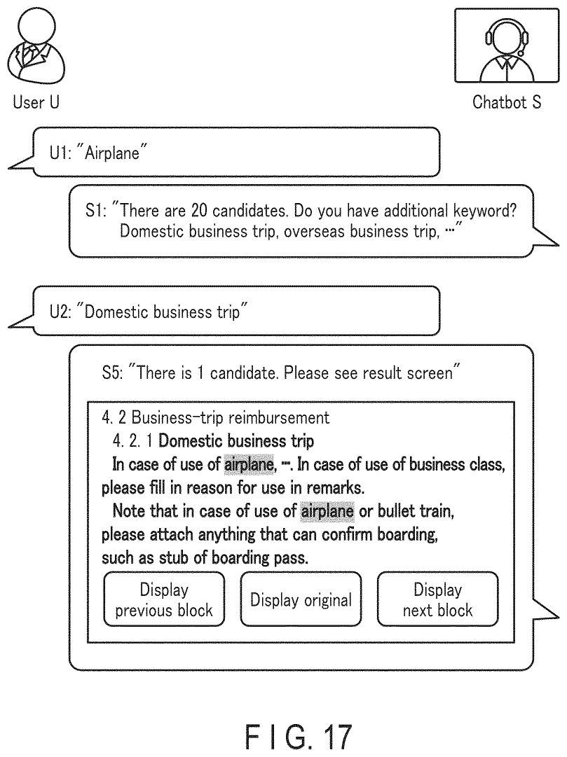

In a case where many pieces of information fail to be displayed in a display device like a smartphone, a document may be displayed in balloons indicating interaction between the user U and the chatbot S, as illustrated in FIG. 17. In a case where there is no margin for simultaneously displaying blocks before and after a block hit in retrieval, a button for moving to the blocks before and after the block may be displayed. Alternatively, a button for switching a display mode for displaying interaction while omitting blocks other than the block hit in retrieval and a display mode for simultaneously displaying the blocks before and after the block hit in retrieval without displaying the interaction may be displayed.

In a case where a plurality of blocks is hit in retrieval, if all of the blocks are displayed in the form of a balloon, too many balloons are displayed, and it is difficult to view. By only displaying a block selected by the selecting unit 1201 in the form of a balloon, a display that is easy to view can be conducted.

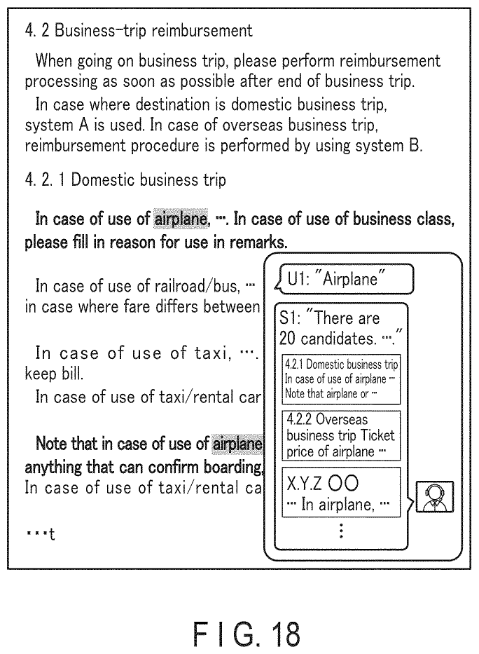

FIG. 18 illustrates another example of the retrieval screen according to the second embodiment. In the example illustrated in FIG. 18, a region displaying the history of interaction between the user U and the chatbot S is superimposed onto a document. A list of blocks hit in retrieval is displayed in a balloon of the chatbot S, and the document is displayed on the entire screen in such a way that a block selected by the selecting unit 1201 is located in a position that is easy to view.

As described above, in the second embodiment, in a case where a plurality of blocks is hit in retrieval, the document retrieving apparatus 1200 sets candidates for an additional query for narrowing a document retrieval result based on a reference feature that is associated with these blocks, and outputs a response that prompts the input of the additional query while proposing the candidates for the additional query. By doing this, a user can also retrieve information that the user does not know well under the leadership of the apparatus.

Each of the document retrieving apparatuses 101, 700, and 1200 can be implemented in a computer. A hardware configuration of a computer that can implement a document retrieving apparatus according to an embodiment is described.

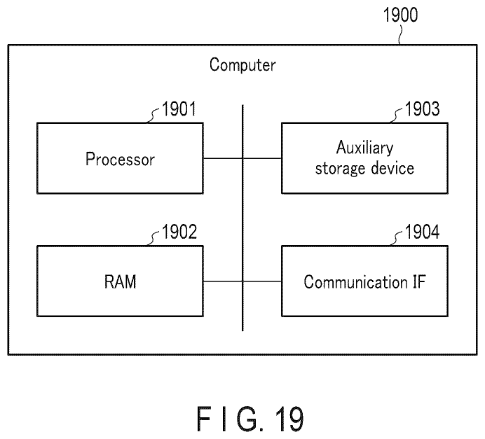

FIG. 19 schematically illustrates an example of a hardware configuration of a computer 1900 according to an embodiment. As illustrated in FIG. 19, the computer 1900 includes a processor 1901, a random access memory (RAM) 1902 serving as a main memory, an auxiliary storage device 1903, and a communication interface 1904.

The processor 1901 includes a general-purpose processor such as a central processing unit (CPU). The RAM 1902 includes a volatile memory such as a synchronous dynamic random access memory (SDRAM), and is used as a working area of the processor 1901. The auxiliary storage device 1903 includes a non-volatile memory such as a hard disk drive (HDD) or a solid state drive (SSD), and stores programs including a document retrieval program, data, and the like.

The processor 1901 operates according to a program stored in the auxiliary storage device 1903. When the document retrieval program is executed by the processor 1901, the document retrieval program causes the processor 1901 to perform processing described with respect to the document retrieving apparatuses 101, 700, and 1200. For example, the processor 1901 functions as the analyzing unit 201, the acquisition unit 211, the retrieving unit 212, the display information generating unit 213, the selecting unit 1201, and the response generating unit 1202 that are included in the document retrieving apparatus 1200 in accordance with the document retrieval program. The auxiliary storage device 1903 functions as the first storage unit 202 and the second storage unit 702 that are included in the document retrieving apparatus 1200.

The communication interface 1904 is an interface for performing communication with an external apparatus. The processor 1901 performs communication with the user terminal 102 and the host device 103 via the communication interface 1904.

Note that the processor 1901 may include a dedicated processor such as a field programmable gate array (FPGA) or an application specific integrated circuit (ASIC) instead of or in addition to the general-purpose processor. The processor 1901 refers to the general-purpose processor, the dedicated processor, or a combination of the general-purpose processor and the dedicated processor. The processor 1901 is also referred to as processing circuitry.

A program such as the document retrieval program may be provided to the computer 1900 in a state stored in a computer-readable recording medium. In this case, the computer 1900 includes a drive that reads data from the recording medium, and acquires the program from the recording medium. Examples of the recording medium include a magnetic disk, an optical disk (a CD-ROM, a CD-R, a DVD-ROM, a DVD-R, or the like), a magneto-optical disk (an MO or the like), and a semiconductor memory. Furthermore, the program may be distributed through a communication network. Specifically, the program may be stored in a server on the communication network, and the computer 1900 may download the program from the server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document retrieving apparatus comprising:
a memory configured to store block information indicating a plurality of blocks and a plurality of reference features that is associated with the blocks, the blocks each being a group of semantically relevant sentences included in a document; and
processing circuitry configured to:
extract a retrieval feature to be used in retrieval from a query that is input;
retrieve a first block that is relevant to the query from the blocks based on matching of the retrieval feature with the reference features; and
generate display information for conducting an emphasis display of the first block.

2. The document retrieving apparatus according to claim 1, wherein the processing circuitry is further configured to perform block division on the document to acquire the blocks, and extract the reference features from the blocks.

3. The document retrieving apparatus according to claim 2, wherein
the block division includes:
calculating a score indicating relevance between two continuous sentences that are included in the document; and
comparing the score with a predetermined threshold in order to determine whether the two sentences are to be caused to belong to an identical block.

4. The document retrieving apparatus according to claim 3, wherein the processing circuitry acquires the blocks by correcting a result of the block division based on structure information of the document.

5. The document retrieving apparatus according to claim 1, wherein the processing circuitry is further configured to determine a candidate for an additional query based on a reference feature that is associated with the first block from among the reference features, and generate a response that prompts an input of the additional query while proposing the candidate.

6. The document retrieving apparatus according to claim 1, wherein
the processing circuitry is further configured to select a second block that is semantically relevant to the first block from the blocks, and
the processing circuitry generates the display information for conducting the emphasis display of the first block and the second block.

7. The document retrieving apparatus according to claim 6, wherein
the memory further stores relevance information indicating semantic relevance between the blocks, and
the processing circuitry selects the second block from the blocks based on the relevance information stored in the memory.

8. The document retrieving apparatus according to claim 1, wherein
the document has a hierarchical structure, and
a reference feature that is associated with each of the blocks includes a first feature and a second feature, the first feature being extracted from the block, the second feature being extracted from a title of a hierarchy that is higher than a hierarchy that includes the block.

9. The document retrieving apparatus according to claim 8, wherein
the processing circuitry generates the display information for conducting the emphasis display of the first block and the title from which the second feature is extracted, in a case where the retrieval feature matches the second feature that is included in a reference feature that is associated with the first block.

10. The document retrieving apparatus according to claim 1, wherein in the display information, the first block is emphasized in a first format, and a feature that matches the retrieval feature included in the first block is emphasized in a second format that is different from the first format.

11. A document retrieving method performed by a computer, the document retrieving method comprising:
acquiring block information indicating a plurality of blocks and a plurality of reference features that is associated with the blocks, the blocks each being a group of semantically relevant sentences included in a document;
extracting a retrieval feature to be used in retrieval from a query that is input;
retrieving a first block that is relevant to the query from the blocks based on matching of the retrieval feature with the reference features; and
generating display information for conducting an emphasis display of the first block.

12. A non-transitory computer readable medium including computer executable instructions, wherein the instructions, when executed by a processor, cause the processor to perform a method comprising:
acquiring block information indicating a plurality of blocks and a plurality of reference features that is associated with the blocks, the blocks each being a group of semantically relevant sentences included in a document;
extracting a retrieval feature to be used in retrieval from a query that is input;
retrieving a first block that is relevant to the query from the blocks based on matching of the retrieval feature with the reference features; and
generating display information for conducting an emphasis display of the first block.
